(19) United States
(12) Patent Application Publication
(10) Pub. No.: US 2012/0271764 A1
(43) Pub. Date: Oct. 25, 2012

(54) FINANCIAL TRADE METHOD AND TRADE SYSTEM USING MOBILE DEVICE FOR THE SAME

(76) Inventor: Ping-Chien CHEN, Tainan City (TW)

(21) Appl. No.: 13/089,446

(22) Filed: Apr. 19, 2011

(51) Int. Cl. G06Q 40/00

(52) U.S. Cl. 705/44; 705/39

(57) ABSTRACT

A financial trade method arranges a combo-chips card internally on a mobile device for trading. The mobile device selects one of the combo-chips card which combines a plurality of chip cards therein via an application program, and the mobile device progresses to swipe in a non-contact sensing mode. After sensing, the mobile device identifies for user thereon according to a request from a financial server, and the mobile device then transmits identification data to the financial server after identifying. Therefore, the financial server determines whether the trade is successful and completed after comparing with the identification data.

### BACKGROUND OF THE INVENTION

1. Field of the Invention

The present invention relates to a card swiping method and system for financial transactions, more particularly relates to a method or system for completing a card swiping transaction through a mobile device.

2. Description of the Related Art

The present is an era where science and technology are highly developed and all styles and kinds of products revolving around human life are gradually being digitized and becoming electronic, which deeply influences all kinds of habits in our human lives.

For example, the transaction method between the general public and financial business, from the traditional deposit and withdrawal at the bank counter, has gradually evolved to the use of banking cards and ATMs (Automated Teller Machine) for deposits and withdrawals. For another example, the transaction method between the general public and the consumer stores has also moved from the traditional cash payment, gradually moving to payment through the swiping of a credit card.

And, as science and technology progress, such payment cards as the above-mentioned banking cards, credit cards . . . and so on have also moved from early magnetic tape and sensor chip cards, slowly evolving to the currently popular non-contact sensor chip cards, allowing more convenient use for users and aiding in the popularity of chip cards.

However, the chip cards with various functions are incompatible with each other; because of this the user usually needs to carry numerous cards with them, in order to carry out different goals. Some common examples are: credit cards, cash cards, banking cards, value added cards and discount cards . . . and so on, which not only brings great distress to the user when carrying them, but the user also often has to place these cards in their bag or wallet. Once the bag or the wallet is lost or stolen, great losses will be incurred by the user.

Moreover, when currently executing a transaction on the market, where the swiping method initiates a payment, the majority of consumer stores will check the identity of the consumer by making them sign their signature. Such a way of checking is unable to hinder someone who tries to use someone else's identity. Therefore, it is common to witness the theft of credit cards and cash cards in society.

In view of this, how to release the users from the distress of carrying many cards, and how to promote the authentication mechanism of those cards effectively so as to reduce the number of lost or stolen cards, is the object the practitioners' painstaking research upon in this field.

### BRIEF SUMMARY

The main purpose of this invention is to provide a financial transaction method and system for use on mobile devices, where a sensor type combo-chip card can be installed inside the mobile device, and when executing a financial transaction, one of these are chosen to proceed with the card sensing transaction.

Another main purpose of this invention is to provide a financial transaction method and system for use on mobile devices, which can directly use the mobile device to proceed with identification after sensing the chip card, so as to make the identification action faster and more convenient and to make the identification data more secure.

In order to reach the above-mentioned purposes, this invention utilizes a combo-chip card installed inside a mobile device, selecting one chip of the combo-chips card through an application program installed inside the mobile device when executing a transaction, using the mobile device to directly proceed with executing a transaction in a non-contact sensing mode. After sensing, according to a request from the financial server, identification actions on the mobile device can proceed and then certifying the transfer of data with the financial server can proceed.

Comparing to the prior art, this invention has at least the following advantages

1. As long as installing a combo-chip card in the mobile device, the user does not need to carry many chip cards with different card functions, such as a credit card, cash card, banking card, value added card, discount card . . . and so on, which is not only convenient, but by combining these different cards into one combo-chip card on the mobile device, it's not easy to lose.

2. The application program of the mobile device can be used to access one chip card on the combo-chip card of the mobile device, thus at the same time having the convenience for arranging, seeking and use.

3. When executing a transaction at the consumer store, the user can directly use the mobile device to sense the consumer store's card reader and proceed with executing a transaction in a non-contact sensing mode.

4. In the process of card sensing, if the financial server requests to proceed with identification, an identification action can be executed on the mobile device directly, without relying on the machine at the consumer store (card reader or other machine for identification). Thus there is a higher level of security and the user does not need to worry that the identification data will be stolen by the store.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a system architecture diagram of a preferred embodiment of the present invention.

FIG. 2A is a schematic diagram showing a combo-chip card of a preferred embodiment of the present invention.

FIG. 2B is an architecture diagram showing a combo-chip card of a preferred embodiment of the present invention.

FIG. 3 is an activating flow chart of a preferred embodiment of the present invention.

FIG. 4 is a flow chart of the card sensing and execution of a transaction of a preferred embodiment of the present invention.

FIG. 5 is a schematic diagram showing a selection page for a combo-chip card of a preferred embodiment of the present invention.

FIG. 6 is a schematic diagram showing the account and password identification for a mobile device of a preferred embodiment of the present invention.

FIG. 7 is a schematic diagram showing the facial feature recognition, fingerprint feature scanning and retina recognition identification for a mobile device of a preferred embodiment of the present invention.

FIG. 8 is a schematic diagram showing the signature identification for a mobile device of a preferred embodiment of the present invention.

FIG. 9 is a schematic diagram showing the fingerprint feature scanning identification for a mobile device of a preferred embodiment of the present invention.

FIG. 10 is a flow chart showing an image password registration of a preferred embodiment of the present invention.

### DETAILED DESCRIPTION

According to the figures, one preferred embodiment of this invention are described as below.

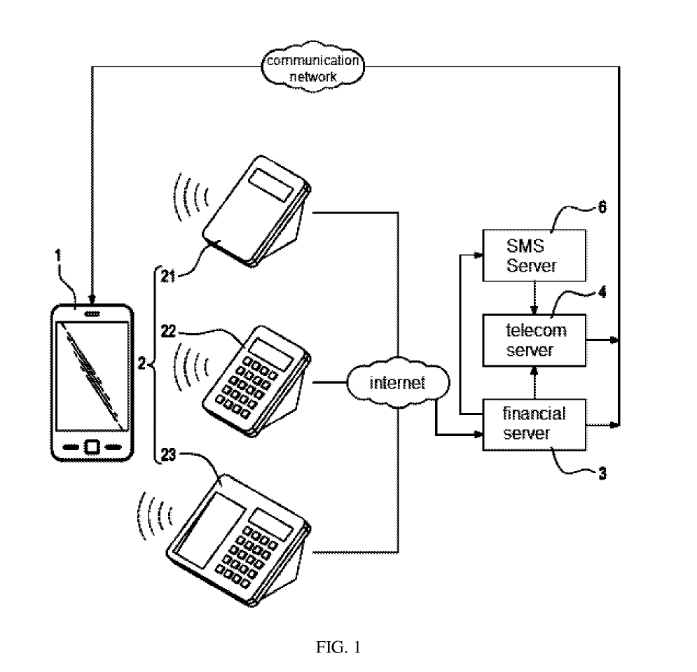

Please refer to FIG. 1, which is a system architecture diagram showing one preferred embodiment of this invention. The financial transaction system of the invention mainly includes: a mobile device 1, a card reader 2, a financial server 3, a telecom server 4 and a SMS (Short Message Service) server 6, wherein the financial server 3, the telecom server 4 and the SMS server 6 are a general server or a cloud server, but not restricted to these servers only. The mobile device 1 is a portable mobile device, such as a mobile phone, Personal Digital Assistant (PDA), Tablet computer, (such as iPad), e-book Reader and Global Positioning System (GPS) . . . , etc., but is not restricted to these abovementioned mobile devices only.

The card reader 2 is mainly a card reader provided by a consumer store or a financial unit (not shown in the figure). The card reader 2 connects to the financial server 3 through the internet, executing a transaction in a non-contact sensing mode with the users chip card (such as credit card, banking card . . . etc.) for payment. After sensing, the card reader 2 transmits the card data of the chip card to the financial server 3.

As shown in FIG. 1, the first card reader 21, not having any input keys, provides basic sensing for small transactions without the need to enter any identification data. The second card reader 22, having input keys, provides a higher security level for swiping in a sensing mode, whereby after sensing, the consumer store or user will, through the input keys, enter an account number or password for authentication of identification data. The third card reader 23 has a recess which has a specific tool used for proceeding with the sensing mode. For example, if the chip card is installed inside the mobile device 1, the user places the mobile device 1 in the recess, and the third card reader 23 can proceed with the sensing mode of mobile device 1. However, the above mentioned is just a preferred embodiment of the invention. Any kind of the card reader 2 for non-contact sensing can be consistent with the application of the present invention, and should not be limited to the abovementioned card readers only.

The financial server 3 set at the financial services provider (not shown in the figure) is a general server or cloud server and the financial server 3 connects to the card reader 2 through the internet, thereby receiving the card data transmitted by card reader 2 and proceeding with the processing action at the end provider. The telecom server 4, which connects with the financial server 3, is a general server or a cloud server installed by telecom carriers. The telecom server 4 confirms a successful sensing action on the financial server 3, and thereafter receives a message with confirmation of a successful sensing action transmitted by financial server 3. In addition, the telecom server 4 is connected with the mobile device 1 via a communication network, and according to information transmitted by the financial server 3 to telecom server 4, a SMS is sent to mobile device 1, notifying the user of a successful sensing transaction.

Moreover, the financial server 3 can directly connect to the mobile device 1 through the internet or communication network; therefore, after the card sensing and transaction is successful, the financial server 3 can transmit a SMS to the mobile device 1 by itself so as to inform the user that the card sensing and transaction is successful without passing through the telecom server 3.

Furthermore, the financial transaction system of this invention can also connect to the SMS server 6. The SMS server 6 is a general server or cloud server, which is purchased from the telecom carriers or installed by a SMS provider for chartering a SMS service. After the financial server 3 confirms that the card sensing and transaction is successful, the financial server 3 transmits a message of successful sensing and transaction to the SMS server 6. Then, the SMS server 6 transmits a SMS to the mobile device 1 via the telecoms server 4 so as to inform the user that the card sensing and transaction is successful.

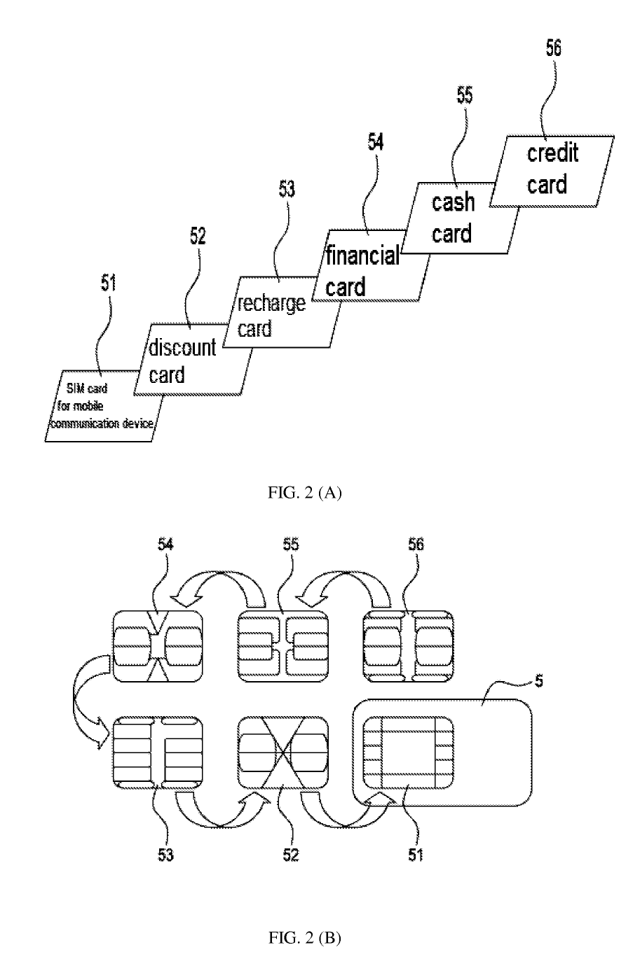

A combo-chip card is installed inside the mobile device 1 (as the combo-chip card showed in FIG. 2B). Accordingly, when executing a transaction, the user of the mobile device 1 can directly proceed with executing a transaction in a non-contact sensing with the card reader 2 by the mobile device 1 so as to activate the card reader 2 to sense one of the chip cards on the combo-chip card 5 inside mobile device 1 (described later).

Wherein, the combo-chip card 5 comprises at least one communication chip card for mobile devices 51 (as the communication chip card for mobile devices 51 shown in the FIG. 2A) and the mobile device 1 communicates through this communication chip card for mobile devices 51. Some of the functions of the communication chip card for mobile devices 51 are call placing and receiving, sending and receiving SMS messages or 3G/4G (including the next technology after 4G) Internet access . . . and so on, but not limited to these abovementioned functions.

Please also refer to FIG. 2A and FIG. 2B, which are a schematic diagram and an architecture diagram showing a combo-chip card of a preferred embodiment of the present invention. As the figures show, the combo-chip card 5 can include the communication chip card for mobile devices 51 for mobile communications, a discount card 52, a value added card 53, a banking card 54, a cash card 55 and a credit card 56 and so on, whereby all these various cards are integrated into one combo-chip card 5. This combo-chip card 5 can be a combination of two chip cards on the combo-chip card 5, three chip cards on the combo-chip card 5, up to and surpassing six chip cards on the combo-card 5, but not limited to the aforementioned configurations. Wherein the communication chip card for mobile devices 51 can be a SIM (Subscriber Identity Module) card, a USIM (Universal Subscriber Identity Module) card or another communication chip card for mobile devices, but not restricted to the aforementioned chip cards.

The discount card 52 can download and store discount coupon information from the Internet or store cash amounts paid, remaining balances and all data related to discounts; the value added card 53 can store the stored-value data for cash or the stored-value data for fictitious points. The credit card 56 could be the credit card chip issued by the domestic and foreign banks

An application program (not shown in the figure) is installed inside the mobile device 1. The mobile device 1 can select one of the chip cards on the combo-chip card 5 via the application program. So the combo-chip card 5 has multiple kinds of card data stored on one combo-chip card 5, and through the application program is able to select one chip card (such as the value added card 53), then subsequently selecting the chip card data on the respective card (such as adding cash to a value added card or storing gaming points on a game storage card, etc.)

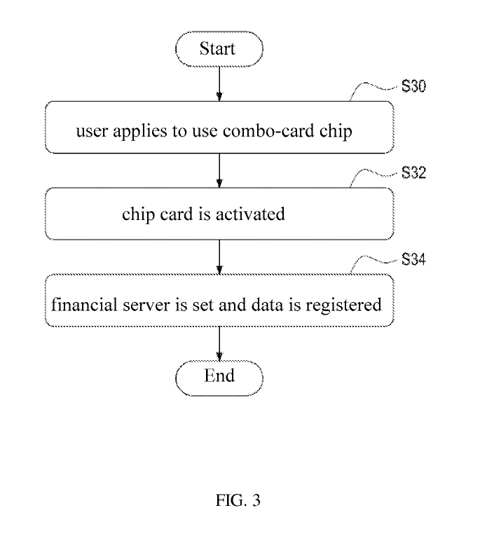

Please refer to FIG. 3, which is an active flow chart of a preferred embodiment of the present invention. Before using the combo-chip card 5 in the mobile device 1, the user needs to apply to the respective financial services provider of the chip cards 52-56 to be able to use the combo-chip card 5 (step S30). Thereafter, the respective chip cards 52˜56 of the combo-chip card 5 are activated by the mobile device 1 (step 32) so as to enable the mobile device 1 to interact with the combo-chip card 5. Finally, the respective financial servers 3 of the chip cards 52˜56 set and register the identification data of the respective chip cards 52-56 (step S34). Wherein, the identification data is, for instance, the user's identification (ID), secret code, facial feature recognition data, retinal feature recognition data, signature data, fingerprint feature scan data and image code data . . . and so on. In this way, when the user proceeds with card sensing by directly using the mobile device 1, if the transaction amount is greater than a set value, the financial server 3 requests the mobile device 1 to identify a user, so as to avoid the inappropriate use of the combo-chip card 5 if the mobile device 1 is lost or stolen.

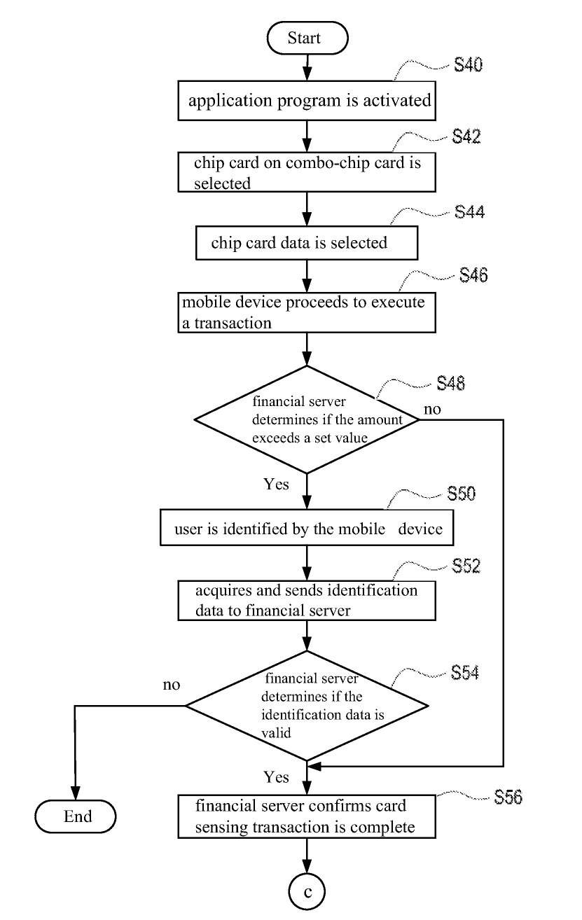

Please refer to FIG. 4, which is a flow chart of the card sensing and execution of a transaction of a preferred embodiment of the present invention. First of all, before the user proceeds with card a sensing transaction, the application program inside the mobile device 1 is activated (step S 40). Thereafter through the application program one of the chip cards on the combo-chip card 5 is selected. (step S42) and finally the respective chip card 52-56 data of the chosen card is accessed on combo-chip card 5 (step S44). After step S44, the mobile device 1 has chosen one chip card 52˜56 of the combo-chip card 5. Accordingly, the user can directly use the mobile device 1 to activate the card reader 2 and proceed to execute a transaction in a non-contact sensing mode (step S46).

Then, after the financial server 3 receives the transaction data, the financial server 3 determines if the transaction amount is greater than a set value (step S48). If the transaction amount does not exceed the set value it will display the transaction is for a small amount and therefore the user does not need to proceed with identification. If the transaction amount is greater than a set value, the user will be identified by the mobile device 1 directly (step S50). Accordingly, after step S50, the mobile device 1 acquires the user's identification data and transmits it to the financial server 3 (step S52). Finally, the financial server 3 compares and determines whether the identification data is valid or not (step S54). If the identification data is not valid, the card sensing transaction will be rejected. If the identification data is valid, the financial server 3 will confirm the card sensing transaction is complete (step S56). In step S52, the mobile device 1 connects to the financial server 3 through the internet, communication network or the card reader 2 to transmit the identification data to the financial server 3, which depends on actual operation and is not limited.

Wherein, the set value is set by the financial server 3 and the user when applying for the combo-chip card 5. For example, the user can set it that when the transaction amount is less than one thousand dollars, there is no need to authenticate identification. Furthermore, the set value can be strictly regulated by the financial services provider of the respective financial server 3 so as to protect the safety of users, but which is not limited.

After the card sensing is successful by using the mobile device 1, the financial server 3 can alternatively request the consumer store to require the user to sign on the receipt (step S58) so as to enable the consumer store to keep a receipt and report back to the financial server 3. However, note that if the mobile device 1 directly proceeds with sensing and identification action, then this step may be omitted.

As described above, after completing the sensing action, the financial server 3 will respond with a successful transaction to the consumer store. (step S60). More specifically, the financial server 3 will respond with a successful transaction message to the card reader 2 at the consumer store. Additionally the financial server 3 notifies telecom server 4 or the SMS server 6 with a message of a successful transaction. (step S62), and a message of a successful transaction is saved on the financial server itself (step S64). Moreover, the steps S60, S62 and S64 don't have to be executed in the abovementioned order, and some of these steps may be omitted, and these steps can be decided and determined by financial server 3, but not restricted to financial server 3.

After the step S62, the telecom server 4 or the SMS Server 6, according to the successful transaction message sent out by the financial server 3, sends a message to the mobile device 1, thereby notifying the user of a successful sensing and transaction (step S66) Finally, the combo-chip card of the mobile device 1 stores a record of the transaction (step S68).

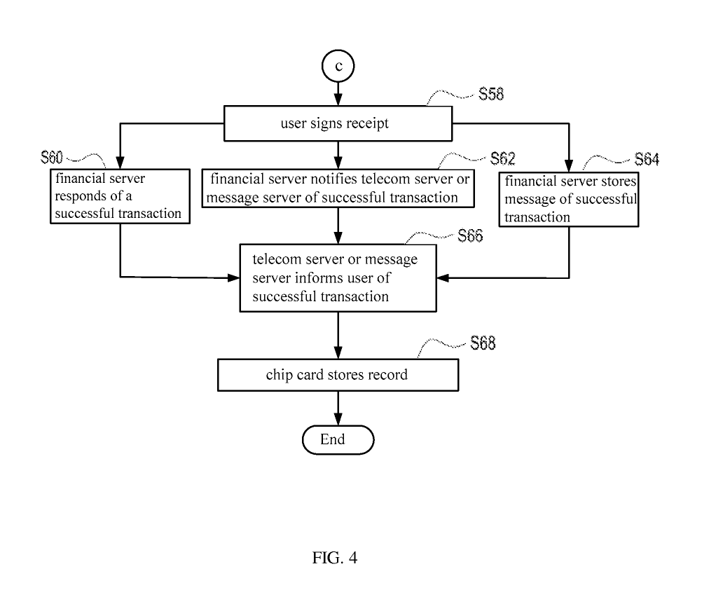

FIG. 5 is a schematic diagram showing a selection page for a combo-chip card in a preferred embodiment of the present invention. As shown in the figure, the mobile device 1 has a display screen 14. The user can open the application program on the mobile device before executing a transaction so as to show chip card selection page 141 on the display screen 14. The user can use a special input key 15 on the mobile device 1 or the touch display screen 14 to select the discount card 52, the value added card 53, the banking card 54, the cash card 55 and the credit card 56 of the combo-chip card 5 on the chip card selection page 141. Additionally the user can select the user transaction record of the respective chip card, to view all user transactions on chip cards 52-56 of the combo-chip card.

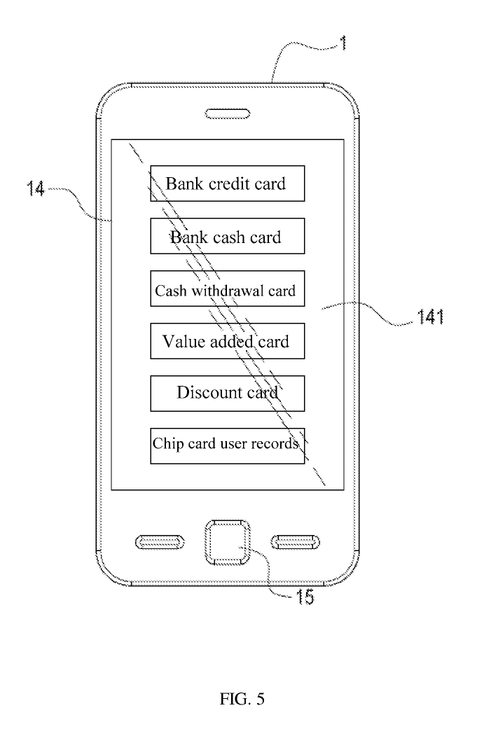

In FIG. 4, the mobile device 1 proceeds with the identification action (step S50) and acquires the identification data and transmits it to the financial server 3 (step S52), which mainly shows that financial server 3 can request mobile device 1 to proceed with identification requirements from the user, and through the mobile device 1 can acquire the users identification account, secret code, facial feature recognition data, retinal feature recognition data, signature data, fingerprint feature scan data and image code data. Shown in FIG. 6 is a schematic diagram showing the account and password identification for a mobile device of a preferred embodiment of the present invention. When the financial server 3 sends a request to the mobile device 1 for the user to authenticate his identification number and at least one password, the mobile device 1 can open the required application, and access account and password page 142.

The user can input the account and password by using the special input key 15 or the touch display screen 14 on the mobile device 1, and this identification data can be transmitted to financial server 3 for authentication action.

However, if the transaction amount is larger, and the financial server 3 requests additional identification data for more security, the mobile device 1, through the hardware and procedures mentioned below, can proceed with identification action by the provided identification data.

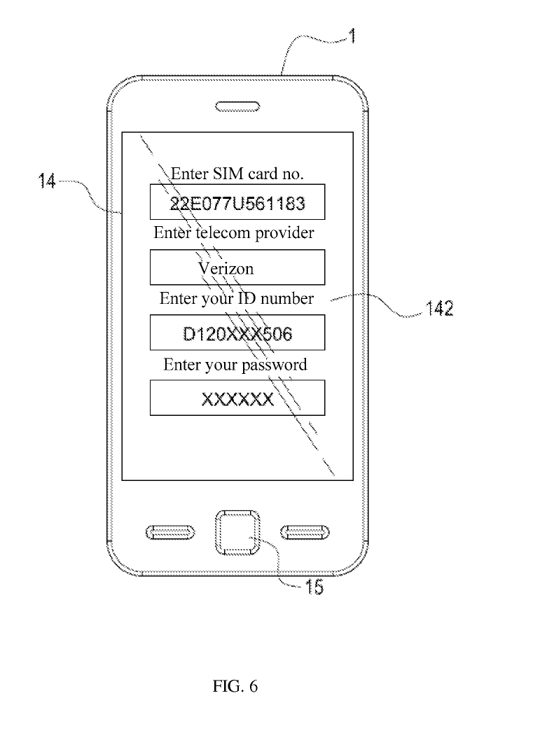

Please refer to FIG. 7, which is a schematic diagram showing the facial feature recognition, fingerprint feature scanning and retina recognition identification for a mobile device of a preferred embodiment of the present invention.

More than one lens is on the same side of the mobile device 1 (which can be a general camera lens or a scanning lens with special features). When the financial server 3 requests the mobile device 1 to identify the user, the mobile device 1 can, through the multiple lenses, proceed with facial feature recognition for identification action.

Shown in FIG. 7 is an example of a first lens 11, a second lens 12 and a third lens 13. However, the mobile device 1 can have the first lens 11 and the second lens 12 only, or can simultaneously have three or more lenses.

In this embodiment, the first lens 11 is a common digital camera lens and the second lens 12 is a camera lens with a high sensitivity. Hereby, with the matching of the first lens 11 and the second lens 12, and the matching of the installed application on mobile device 1, mobile device 1 can achieve the 3D facial features recognition. The third lens 13 can be a scanning lens with Retina Recognition function. Hereby, with the matching of the second lens and the scanning lens, and through the installed application software, mobile device 1 can achieve the 3D˜4D facial recognition action and thereby increasing the precision of the identification action when scanning and raising the user security on the combo-chip card 5.

Simultaneously, if the mobile device 1 has a scanning lens with Retina Recognition function installed, (as in the third lens 13), the mobile device 1 can recognize the retinal feature of the user or execute the fingerprint scanning feature via the third lens 13 so as to treat the retinal feature recognition data and the fingerprint feature recognition data as the identification data for authentication purposes.

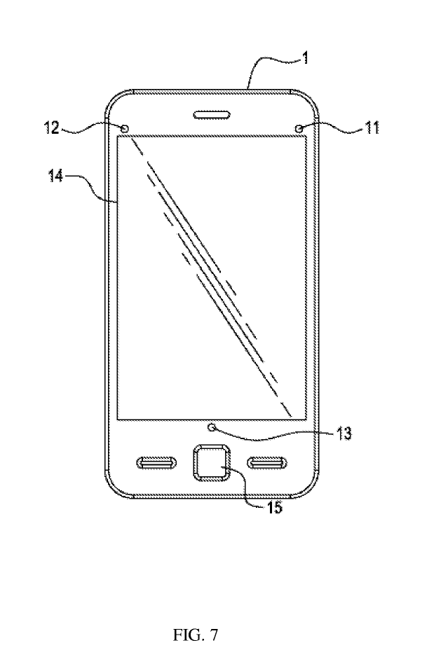

Please refer to FIG. 8, which is a schematic diagram showing the signature identification for a mobile device of a preferred embodiment of the present invention. When the financial server 3 requests the mobile device 1 to identify the user, the mobile device 1 can open this application program so as to enter mobile device signature page 143. In this embodiment, the display screen 14 on the mobile device 1 is a touch panel. The user can directly sign on the display screen 14. After signing, the mobile device 1 will treat the signed data of the user as the identification data and transmit the data to the financial server 3 for authentication purposes.

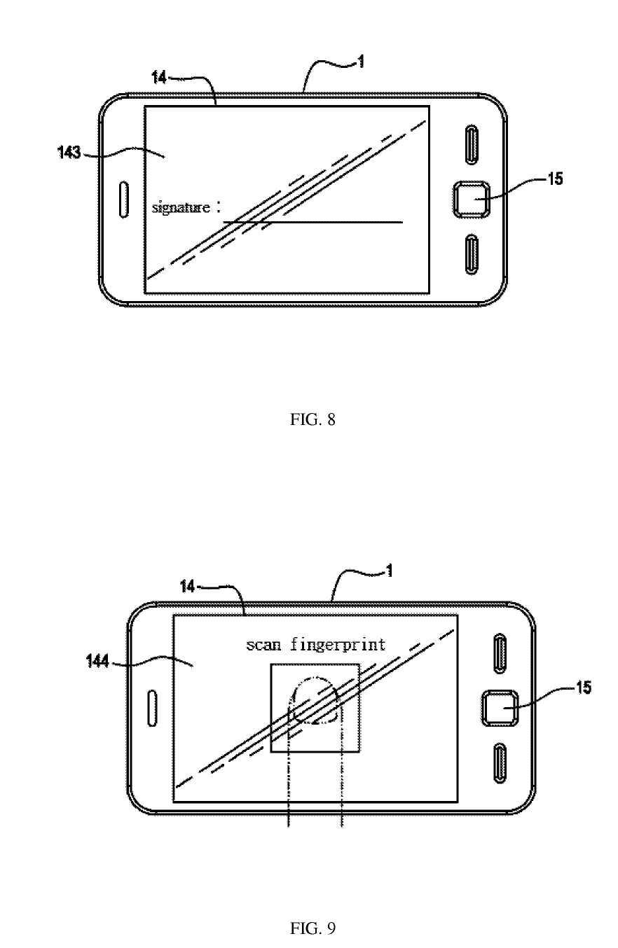

Please refer to FIG. 9, which is a schematic diagram showing the fingerprint scanning identification feature of a mobile device as a preferred embodiment of the present invention. When the financial server 3 requests the mobile device 1 to identify the user, the mobile device 1 can open the application program so as to enter mobile device fingerprint scanning page 144. In this embodiment, the display screen 14 of the mobile device 1 is a touch panel. The user can, through the internal elements of the device and the application program put any finger on the display screen 14 to proceed with scanning After the scanning operation, the mobile device 1 will treat any scanned fingerprint data as the identification data and transmit this to the financial server 3 for identification by comparing with pre-recorded fingerprint data.

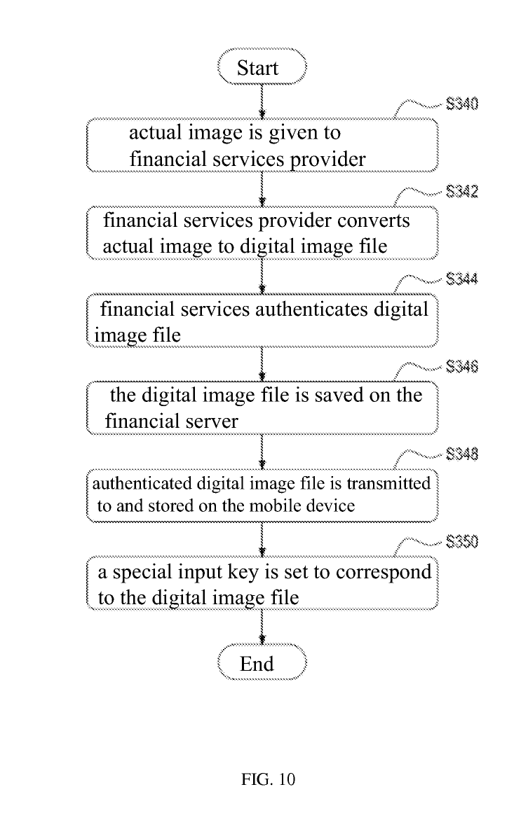

Please refer to FIG. 10, which is a flow chart showing an image password registration of a preferred embodiment of the present invention. In addition to the above mentioned identification methods for the user's identification, a secret code, facial feature recognition, retina feature recognition, signature and fingerprint feature scan . . . and so on, this embodiment provides a method for identification through an image.

Firstly, in the above mentioned step (step S34) of the identification data of setting and registering the respective chip cards 52˜56, the user provides an actual photo to the financial services provider belonging to the financial server 3 (step S340). Then, the financial services provider converts the actual photo into a digital image file (step S342). Meanwhile, the financial services provider authenticates the digital image file (step S344). Finally, the financial services provider stores the identified digital image file on the financial server 3 (step S346).

At the same time, the financial services provider transmits the already identified digital image file to the mobile device 1 for storing (step S348). Thus, in the card sensing process, when the financial server 3 requests the mobile device 1 to identify the user, the user can transmit the digital image file to the financial server 3 for identification. Hereby confirming that the combo-chip card 5 is corresponding and interacting with mobile device 1, the financial server 3 can authenticate the digital image file and confirm that the card sensing is successful.

Moreover, the mobile device 1 can selectively set the digital image file to correspond with the input key 15 of the mobile device 1 (step S350). Thus, when identification is required, the user just needs to press input key 15, and the digital image will automatically be sent to financial server 3 for identification, thereby speeding up the identification process.

As described above, the present invention provides a transaction system and transaction method which is practical, convenient, and secure and which can effectively improve the users trading habits.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A financial transaction system used by mobile devices, comprising:
a mobile device arranging a combo-chip card therein, wherein the combo-chip card comprises at least one communication chip for the mobile devices, the mobile device proceeding with communication functions through this communication chip for the mobile devices;
a card reader, for non-contact sensing of one chip card on the combo-chip card of the mobile device, to read data on the chip card and to proceed with a card sensing and transaction; and
a financial server, connecting to the card reader through the internet, receiving combo-chip card data acquired from the card reader, so as to proceed with processing action at the end provider;
wherein, when a transaction amount is greater than a set value, the financial server requests the mobile device belonging to the chip card to proceed to identify a user and transmits an identification data to the financial server for comparison and after the identification data is authenticated processing action starts.

2. The financial transaction system used by mobile devices of claim 1, which further comprises a telecom server connecting to the financial server, receiving a successful message from the financial server after completing the card sensing and transaction, and transmitting a SMS/message to the mobile device so as to inform the user of the successful transaction.

3. The financial transaction system used by mobile devices of claim 1, wherein one of the chip cards on the combo-chip card is a communication chip for mobile devices, this can be a Subscriber Identity Module SIM card or a Universal Subscriber Identity Module USIM card, the combo-chip card further comprising at least one of a discount card, a value added card, a banking card, a cash card or a credit card, wherein an application program is installed on the mobile device, which is opened when the mobile device proceeds with a financial transaction, and one chip card on the combo-chip card is selected so as to proceed with card sensing.

4. The financial transaction system used by mobile devices of claim 3, wherein a same side on the mobile device has more than one camera lens or scanning lens, the mobile device executes identification of a facial feature, fingerprint or retina feature for the user via the more than one camera lens or scanning lens.

5. The financial transaction system used by mobile devices of claim 3, wherein the mobile device opens the application program, making the user sign or use the fingerprint scanner on a display screen of the mobile device

6. A financial transaction method used by a mobile device, wherein a combo-chip card is installed therein, wherein the combo-chip card comprises at least one communication chip for the mobile devices, the mobile device proceeding with communication functions through this communication chip for the mobile devices, the financial transaction method used by the mobile device comprising:
opening an application program installed within the mobile device;
selecting one chip card on the combo-chip card;
proceeding with card sensing directly to the mobile device via a card reader;
determining that the card sensing is successful at an end provider of a financial server;
storing a message of a successful transaction on the financial server;
replying with a message of a successful transaction from the financial server to the card reader;
notifying of a successful transaction from the financial server to a telecom server or message server;
transmitting of a message to the mobile device by the telecom server or the message server with notification of the successful transaction; and
storing a record of the transaction on the combo-chip card.

7. The financial transaction method used by a mobile device of claim 6, wherein the step of selecting one chip card on the combo-chip card further comprises:
selecting a card classification of one chip card on the combo-chip card; and
selecting chip card data from the card classification.

8. The financial transaction method used by a mobile device of claim 7, further comprising the following steps:
applying for using the combo-chip card on the mobile device;
activating each chip card on the combo-chip card; and
setting up of the financial server and registering an authentication data for each chip card.

9. The financial trade method used by a mobile device of claim 8, further comprising the following steps:
determining whether a transaction amount is greater than a set value;
where the transaction amount exceeds the set value, the mobile device proceeds with an action to identify the user, and after acquiring the authentication data, the authentication data is transmitted to the financial server;
comparing the authentication data to check if its valid on the financial server; and
completing the transaction if the financial server verifies the authentication data.

10. The financial transaction method used by a mobile device of claim 9, wherein if the transaction amount is greater than the set value, the steps for proceeding with identification by the mobile device further comprise:
inputting an ID account number and secret code of the user via the mobile device.

11. The financial transaction method used by a mobile device of claim 9, wherein if the transaction amount is greater than the set value, the steps for proceeding with identification by the mobile device further comprise:
opening the application program to proceed with facial feature recognition, fingerprint feature scan or retina feature recognition of the user via the more than one camera lens or scanning lens of the mobile device.

12. The financial transaction method used by a mobile device of claim 10, wherein if the transaction amount is greater than the set value, the steps for proceeding with identification by the mobile device further comprise:
opening the application program to proceed with identification through the users signature or scanning of a fingerprint on the display screen of the mobile device.

13. The financial transaction method used by a mobile device of claim 9, wherein the steps for setting and registering the identification data further comprises:
providing an actual picture to a financial services provider;
converting the actual picture into a digital image file by the financial services provider;
proceeding with authentication of the digital image file by the financial services provider;
storing of the digital image file on the financial server after authentication by the financial services provider;
transmitting the digital image file to the mobile device for storing on the mobile device by the financial service provider; and
setting the digital image file relative to a special key on the mobile device.

14. The financial transaction method used by a mobile device of claim 13, wherein if the transaction amount is greater than the set value, the steps for proceeding with identification on the mobile device further comprise:
transmitting the digital image file stored in the mobile device to the financial server via pressing of the special key on the mobile device.
